(19) United States
(12) Patent Application Publication
(10) Pub. No.: US 2006/0002257 A1
(43) Pub. Date: Jan. 5, 2006

(54) Information reproducing apparatus and control method therefor

(75) Inventor: Masahiro Takayama, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/151,457

(22) Filed: Jun. 14, 2005

(30) Foreign Application Priority Data
Jun. 30, 2004 (JP) 2004-194933

(51) Int. Cl. G11B 5/09

(52) U.S. Cl. 369/47.1; 369/53.17

(57) ABSTRACT

An information reproducing apparatus is disclosed which recovers a video signal and an audio signal from input information, displays the video signal on a display unit, and reproduces the audio signal by a loudspeaker. When restriction information extracted from a broadcast signal indicates restrictions on video display, reproduction restrictions based on the restriction information are imposed on video display by the display unit. When the restriction information indicates restrictions on audio reproduction, reproduction restrictions based on the restriction information are imposed on audio reproduction by the loudspeaker.

### CROSS-REFERENCE TO RELATED APPLICATIONS

This application is based upon and claims the benefit of priority from prior Japanese Patent Application No. 2004-194933, filed Jun. 30, 2004, the entire contents of which are incorporated herein by reference.

### BACKGROUND OF THE INVENTION

1. Field of the Invention

The present invention relates to an information reproducing apparatus applicable to a portable broadcast receiving terminal by way of example and a control method therefor, and more particularly to improvements for use in facilities such as buildings, railroads, etc.

2. Description of the Related Art

In recent years, mobile phones have been subject to an increase in their functions and performance, and small-sized, lightweight and large-capacity recording media, such as mini disks (MDs), have been developed. Accordingly, portable information reproducing terminals adapted to reproduce information recorded on such recording media have come into wide spread use.

At present, in addition to satellite digital broadcasting and terrestrial digital broadcasting, satellite-based mobile broadcasting is planned, the main candidates for services of which are mobiles such as portable broadcast receiving terminals. In terrestrial digital broadcasting as well, low-data-rate broadcasting (one-segment broadcasting) is planned, the main candidates for services of which are mobiles.

Portable information reproducing apparatuses, exemplified by the aforementioned mobile phones, information reproducing terminals, and broadcast receiving terminals, are allowed for use in specific facilities, such as public buildings, railroads, etc., and therefore need to limit volume or the like for appropriate use in such facilities.

However, when users limit the volume, the volume set varies from user to user; that is, at present, no unified volume control is performed. At present, in many cases, there is no indication of to which degree the volume is to be limited to in the facilities. In most cases, the users merely limit the volume according to their own judgment.

For example, Japanese Unexamined Patent Publication No. 2002-123801 discloses a reproducing apparatus adapted to check the legality of reproducing contents or restrict reproduction according to conditions of reproducing equipment, date and time or term, area, etc. However, this reproducing apparatus employs condition information recorded on a recording medium to check the legality of reproducing content or restrict reproduction and is therefore difficult to meet conditions which vary from facility to facility.

### BRIEF SUMMARY OF THE INVENTION

According to an embodiment of the present invention, there is provided an information reproducing apparatus comprising: a receiving unit which receives a broadcast signal; an extraction unit which extracts restriction information from the broadcast signal received by the receiving unit; a processing unit which recovers a video signal and an audio signal from input information; a display unit which displays the video signal recovered by the processing unit; a loudspeaker which reproduces the audio signal recovered by the processing unit; and a control unit which, when the restriction information extracted by the extraction unit indicates restrictions on video display, imposes reproduction restrictions based on the restriction information on display of the video signal by the display unit, and, when the restriction information extracted by the extraction unit indicates restrictions on audio reproduction, imposes reproduction restrictions based on the restriction information on audio reproduction by the loudspeaker.

According to another embodiment of the present invention, there is provided a method of controlling an information reproducing apparatus equipped with a processing unit which recovers a video signal and an audio signal from input information, a display unit which displays the video signal recovered by the processing unit, and a loudspeaker which reproduces the audio signal recovered by the processing unit, comprising the steps of: receiving a broadcast signal; extracting restriction information from the received broadcast signal; when the extracted restriction information indicates restrictions on video display, imposing reproduction restrictions based on the restriction information on display of the video signal by the display unit; and when the extracted restriction information indicates restrictions on audio reproduction, imposing reproduction restrictions based on the restriction information on audio reproduction by the loudspeaker.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a broadcast receiving apparatus according to an embodiment of the present invention;

FIG. 2 is a block diagram of a signal processing system used in the broadcast receiving apparatus of the embodiment;

FIG. 3 is a flowchart illustrating a part of the main operation of the broadcast receiving apparatus of the embodiment;

FIG. 4 is a flowchart illustrating the remainder of the main operation of the broadcast receiving apparatus of the embodiment;

FIG. 5 shows a modification of the broadcast receiving apparatus of the embodiment;

FIG. 6 is a flowchart illustrating a part of the main operation of the modification of the broadcast receiving apparatus of the embodiment;

FIG. 7 is a flowchart illustrating the remainder of the main operation of the modification of the broadcast receiving apparatus of the embodiment; and

FIG. 8 is a flowchart illustrating the operation of another modification of the broadcast receiving apparatus of the embodiment.

### DETAILED DESCRIPTION OF THE INVENTION

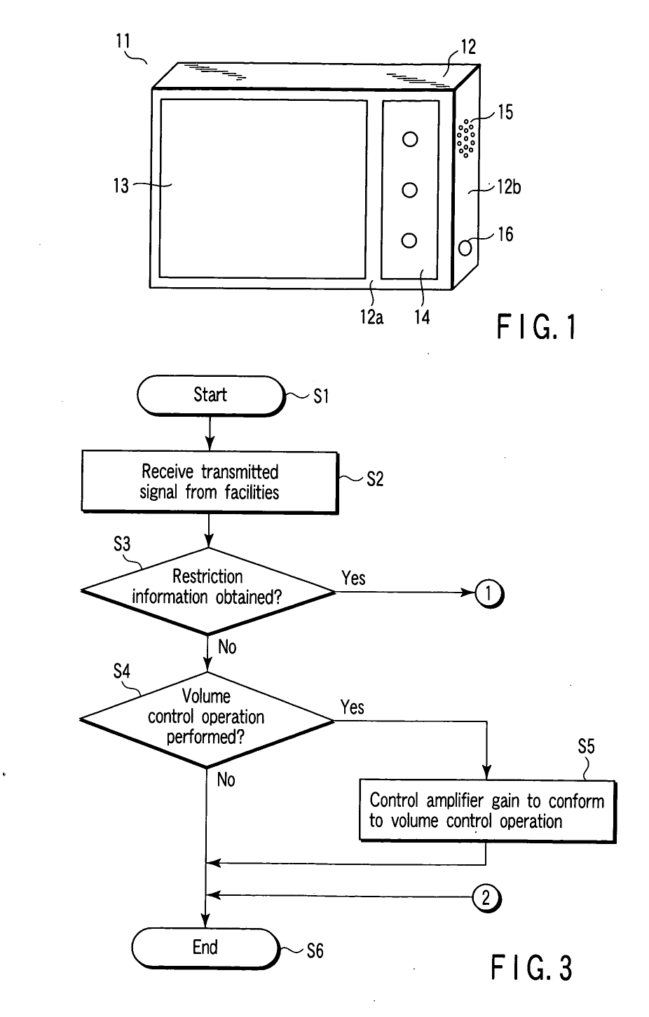

An embodiment of the present invention will be described in detail below with reference to the accompanying drawings. FIG. 1 is an exterior view of a broadcast receiving apparatus 11 as an information reproducing apparatus according to this embodiment. The broadcast receiving apparatus 11 has a portable, thin box-like housing 12.

The housing 12 of the broadcast receiving apparatus 11 is provided on the front 12a with a display unit 13 and a control panel 14 and on one side 12b with a loudspeaker 15 and an audio-signal outputting connector 16 for connecting headphones or the like.

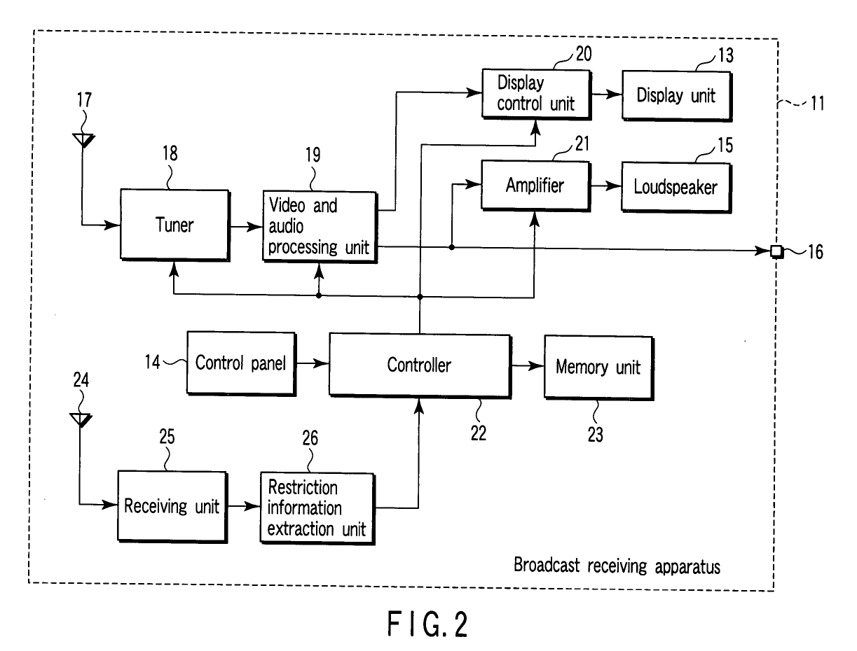

FIG. 2 shows a signal processing system in the broadcast receiving apparatus 11. Broadcast signals received by an antenna 17 built into the housing 12 are applied to a tuner 18 where a signal on a selected channel is selected.

The broadcast signal selected by the tuner 18 is applied to a video and audio processing unit 19 where a demodulation process is carried out on the signal to recover a video signal and an audio signal. The video signal is then applied to a display control unit 20 where it is converted into a format displayable on the display unit 13. The resulting video signal is applied to the display unit 13 and displayed.

The audio signal recovered in the video and audio processing unit 19 is applied to an amplifier 21 where it is amplified. The amplified audio signal is then applied to the loudspeaker 15 to provide sound reproduction. The audio signal recovered in the video and audio processing unit 19 is also applied to the connector 16 for providing audio output to the outside.

The broadcast receiving apparatus 11 has its all operations including the receiving operation described above controlled by a controller 22. The controller 22 has a central processing unit (CPU) not shown built in and receives operation information from the control panel 14 to control each component so that the contents of operations are reflected.

In this case, the controller 22 utilizes a memory unit 23. The memory unit 23 includes a read-only memory (not shown) stored with a control program executed by the CPU in the controller 22, a read/write memory (not shown) serving as a working area for the CPU, and a nonvolatile memory (not shown) stored with various pieces of setting information and control information.

The broadcast receiving apparatus 11 has another antenna 24 built in to receive broadcast signals from various facilities, such as buildings, railroads, roads, etc., each of the broadcast signals containing information associated with corresponding facilities.

A broadcast signal received by the antenna 24 is demodulated in a receiving unit 25 and then applied to a restriction information extraction unit 26. The restriction information extraction unit 26 extracts restriction information indicating reproduction restrictions from the input signal and then outputs it to the controller 22. Thereby, the controller 22 is allowed to control each component so as to meet restriction information transmitted from the corresponding facilities. Thus, reproduction restrictions which vary from facility to facility are realized.

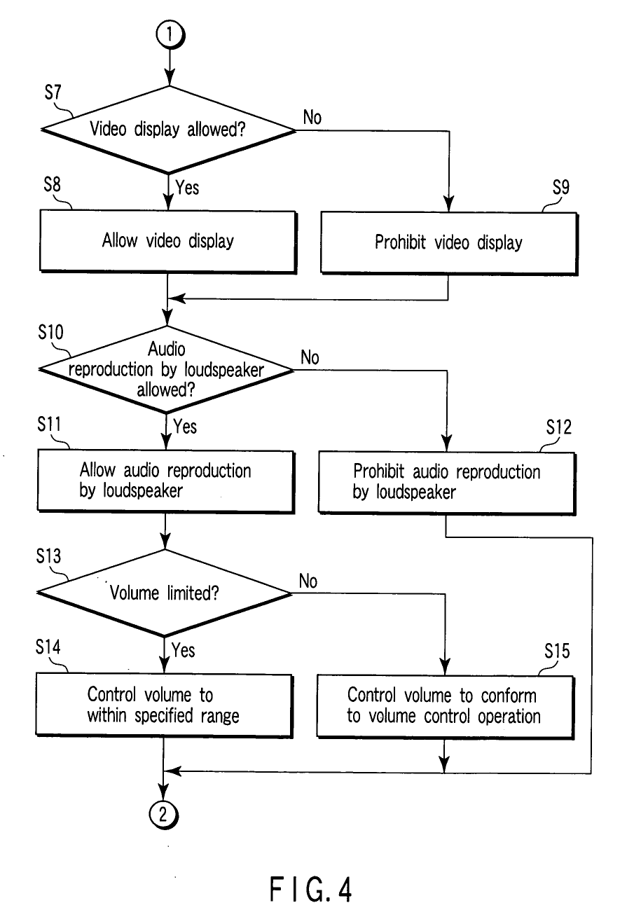

FIGS. 3 and 4 show a flowchart illustrating a reproduction restriction operation performed by the broadcast receiving apparatus 11 on the basis of a broadcast signal transmitted from facilities. The process is started in step S1. Upon receiving a broadcast signal from facilities, the controller 22 makes a determination of whether or not restriction information has been obtained from the restriction information extraction unit 26.

When the determination is that no restriction information is obtained (NO), the controller 22 makes a determination of whether or not a volume control operation is performed on the control panel 14. When the determination is that no volume control operation is performed (NO), the process is completed (step S6).

If the determination in step S4 is that the volume control operation has been performed (YES), the controller 22 controls, in step S5, the gain of the amplifier 21 to conform to the volume control operation and completes the process (step S6).

If the determination in step S3 is that the restriction information has been obtained (YES), the controller 22 makes a determination, in step S7, of whether or not the restriction information allows video display. If the determination is that video display is allowed (YES), the controller 22 controls, in step S8, the display control unit 20 so as to allow the display unit 13 to make video display. Otherwise, the controller controls the display control unit 20 so as not to display the video signal on the display unit 13, thereby stopping video display by the display unit 13.

In step S10 subsequent to step S8 or step S9, the controller 22 makes a determination of whether or not the restriction information allows audio reproduction by the loudspeaker 15. If the determination is that audio reproduction is allowed (YES), the controller 22 controls, in step S1, the amplifier 21 so as to allow audio reproduction by the loudspeaker 15.

If the determination in step S10 that audio reproduction is not allowed (NO), the controller 22 controls the amplifier 21 so as not to cause the loudspeaker 15 to reproduce audio and then completes the process (step S6). In that case, since an audio signal is output from the connector 16, audio reproduction through headphones is allowed.

In step S13 subsequent to step S11, the controller 22 makes a determination of whether or not volume is limited. If the determination is that the volume is limited (YES), the controller 22 controls, in step S14, the amplifier 21 so as to keep the volume to within a specified range and then completes the process (step S6).

Specifically, even if a volume control operation is performed on the control panel 14, the controller 22 controls the amplifier 21 so that the volume is kept to within the specified range. Thereby, even if the currently set volume is beyond the specified range, it is automatically kept to within the specified range. In this case, it is possible to hold the volume set prior to restriction and automatically restore that volume when the restriction is removed.

If the determination in step S13 is that the volume is not limited (NO), the controller 22 controls, in step S15, the gain of the amplifier 21 so that the volume becomes the one set by the volume control operation on the control panel 14 and then completes the process (step S6).

Thereby, if the volume has been limited, the volume is automatically restored to the level before it is limited.

According to the embodiment described above, since the reproduction of video or audio is automatically restricted on the basis of restriction information contained in a broadcast signal from facilities, information reproduction can be made to automatically conform to reproduction conditions which vary from facility to facility. Therefore, the broadcast receiving apparatus can be made much easier to handle.

If the user leaves facilities that disable receiving a broadcast signal, the reproduction restrictions are automatically removed. Even in this respect, the broadcast receiving apparatus can be made much easier to handle.

If, when video display is allowed and audio reproduction by the loudspeaker 15 is prohibited, character information is contained in a received broadcast signal, a character on-screen display can be displayed on the display unit 13.

If an upper limiting value for volume is set in restriction information, then the volume can be kept below the upper limiting value even if a volume control operation is performed.

Moreover, if restriction information contains a video signal displaying a message indicating its contents, the message can be displayed on the display unit 13 with superimposition upon a video signal obtained from a broadcast signal. It is also possible to cause the controller 22 to produce a video signal corresponding to a message indicating the contents of restriction information and display the message on the display unit 13 with superimposition upon a video signal obtained from a broadcast signal.

If, when restriction information prohibits both video display and audio reproduction by the loudspeaker 15, a message to the effect that video display and audio reproduction cannot be made according to the restriction information, the user will not mistake such a situation for a failure.

When restriction information contains information indicating a recommended broadcast channel in facilities, it is also possible to automatically select that broadcast channel. In that case, by displaying the presence of a recommended broadcast channel and its channel number on the display unit 13 prior to selection of the broadcast channel, it becomes possible to prompt the user to select that broadcast channel.

When restriction information contains information to prohibit the use of the broadcast receiving apparatus 11 in facilities, the power to the broadcast receiving apparatus may be turned off.

If restriction information contains information to identify facilities, the number of times the user visited the facilities can be stored by counting the number of times reproduction restrictions were removed. In addition, the dates and times of visit to the facilities can also be stored. In this way, the user will be allowed to receive service the facilities offer on the basis of the number of visits during a certain period.

It is also possible to allow restriction information to contain time information and carry out reproduction restrictions only during a particular period of time. Furthermore, it is also possible to carry out reproduction restrictions the contents of which vary from period to period.

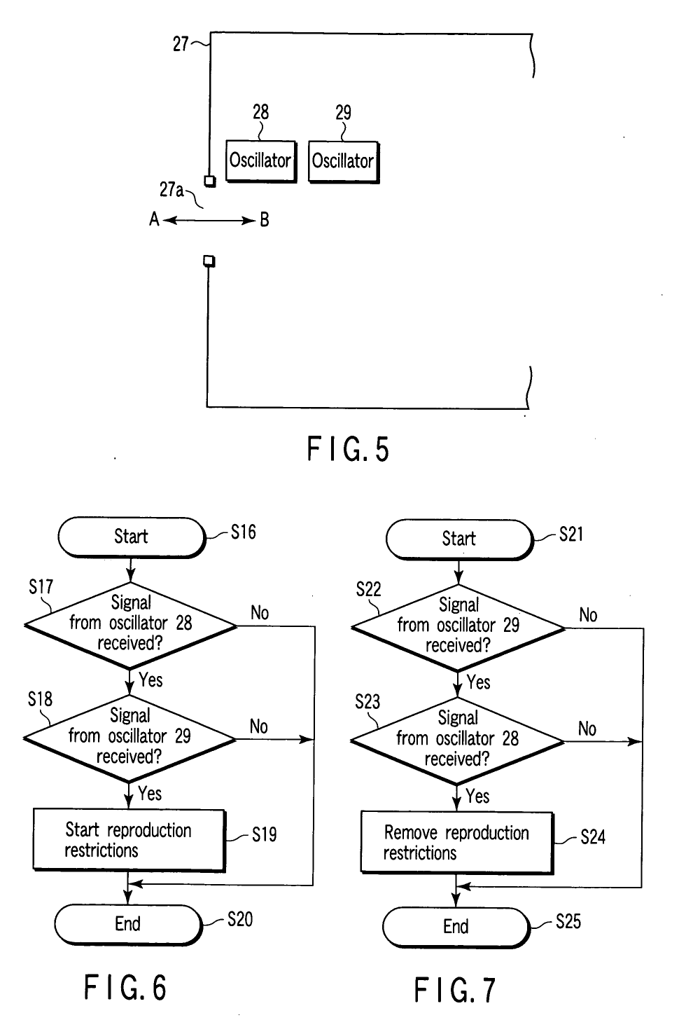

A modification of the embodiment described above will be described next. As shown in FIG. 5, two oscillators 28 and 29 are placed along the direction of people coming and going indicated by arrows A and B at a doorway 27a of a building 27. The oscillators 28 and 29 produce signals of different frequencies. In this case, the oscillator 28 is located in the proximity of the doorway 27a, while the oscillator 29 is located distant from the doorway.

When the user with the broadcast receiving apparatus 11 enters the building 27 through the doorway 27a as indicated by arrow B, the broadcast receiving apparatus will first receive a signal from the oscillator 28 and then receive a signal from the oscillator 29.

When the user goes out of the building 27 through the doorway 27a as indicated by arrow A, the broadcast receiving apparatus will first receive the signal from the oscillator 29 and then receive the signal from the oscillator 28.

The signals from the oscillators 28 and 29 are received by the antenna 24 and then applied through the receiving unit 25 to the restriction information extraction unit 26 where their frequencies are discriminated. The result of discrimination is sent to the controller 22. Thus, the controller 22 is allowed to judge from which of the oscillators 28 and 29 the signal is being received at present.

Upon judging that the signal from the oscillator 28 was first received and then the signal from the oscillator 29 was received, the controller 22 judges that the user has entered the building 27 and is subject to reproduction restrictions through restriction information which is broadcast in the facilities.

FIG. 6 is a flowchart illustrating the operation when the broadcast receiving apparatus is subject to reproduction restrictions after judging that the user has entered the building 27. When the process is started (step S16), the controller 22 makes, in step S17, a determination of whether or not the signal from the oscillator 28 has been received. If the determination is that the signal has not been received (NO), the process is completed (step S20).

If the determination is that the signal from the oscillator 28 has been received (YES), the controller 22 makes, in step S18, a determination of whether the signal from the oscillator 29 has been received. If the determination is that the signal has not been received (NO), the process is completed (step S20).

If, on the other hand, the determination in step S18 is that the signal from the oscillator 29 has been received (YES), the controller 22, in step S19, starts reproduction restrictions associated with the facilities and then completes the process (step S20).

Upon judging that the signal from the oscillator 29 was first received and then the signal from the oscillator 28 was received, the controller 22 judges that the user has gone out of the building 27 and then removes the reproduction restrictions based on restriction information which is broadcast in the facilities.

FIG. 7 is a flowchart illustrating the operation when the broadcast receiving apparatus removes the reproduction restrictions after judging that the user has gone out of the building 27. When the process is started (step S21), the controller 22 makes, in step S22, a determination of whether or not the signal from the oscillator 29 has been received. If the determination is that the signal has not been received (NO), the process is completed (step S25).

If the determination is that the signal from the oscillator 29 has been received (YES), the controller 22 makes, in step S23, a determination of whether the signal from the oscillator 28 has been received. If the determination is that the signal has not been received (NO), the process is completed (step S25).

If, on the other hand, the determination in step S23 is that the signal from the oscillator 28 has been received (YES), the controller 22 removes the reproduction restriction associated with the facilities and then completes the process (step S25).

According to the above operation, the broadcast receiving apparatus carries out reproduction restrictions associated with facilities by detecting that the user has entered the building 27 and removes the reproduction restriction by detecting that the user has gone out of the building, thus allowing reliable reproduction restriction to be carried out. For example, it becomes possible to prevent a malfunction such that reproduction restrictions are carried out as a result of receiving leakage restriction information though the user is outside the building 27.

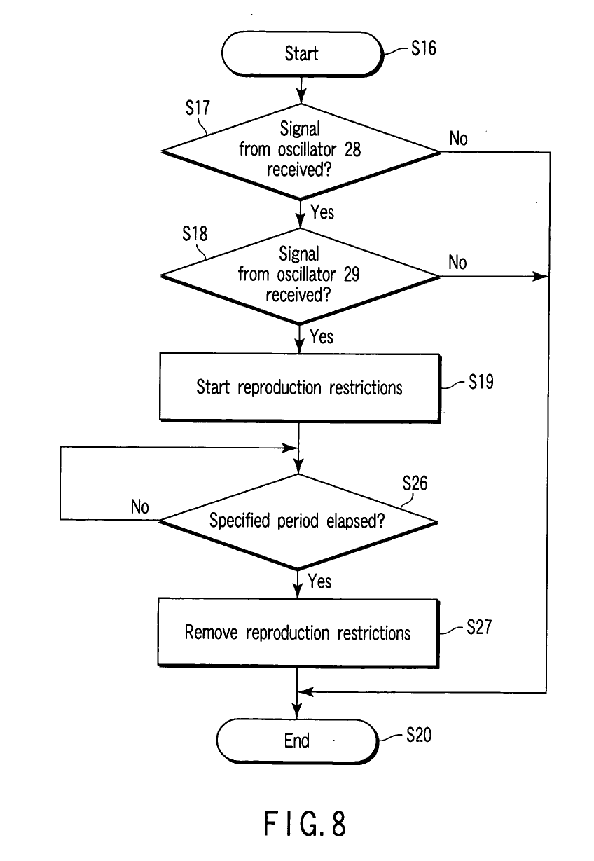

FIG. 8 shows another modification of the embodiment described above. In FIG. 8, the corresponding steps to those in FIG. 6 are denoted by like reference numerals. The controller 22 makes, in step S26, a determination of whether or not a certain period has lapsed after the start of reproduction restrictions in step S19. If the determination is that the certain period has lapsed (YES), the controller 22 removes the reproduction restrictions in step S27 and then completes the process (step S20). Thereby, the reproduction restrictions are allowed only for a certain period after the user has entered the building 27.

Although the embodiment and modifications have been described in terms of a broadcast receiving apparatus, the invention can be widely applied to mobile phones, recording and reproducing equipment, etc.

The present invention is not limited to the embodiments described above. At the stage of practice of the invention, constituent elements can be embodied in modified forms without departing from the scope thereof. The constituent elements disclosed in the above embodiments can be combined appropriately to form various inventions. For example, some elements may be removed from all the constituent elements shown in the embodiments. In addition, the constituent elements in the difference embodiments may be combined appropriately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information reproducing apparatus comprising:
a receiving unit which receives a broadcast signal;
an extraction unit which extracts restriction information from the broadcast signal received by the receiving unit;
a processing unit which recovers a video signal and an audio signal from input information;
a display unit which displays the video signal recovered by the processing unit;
a loudspeaker which reproduces the audio signal recovered by the processing unit; and
a control unit which, when the restriction information extracted by the extraction unit indicates restrictions on video display, imposes reproduction restrictions based on the restriction information on display of the video signal by the display unit, and, when the restriction information extracted by the extraction unit indicates restrictions on audio reproduction, imposes reproduction restrictions based on the restriction information on audio reproduction by the loudspeaker.

2. The information reproducing apparatus according to claim 1, further comprising a connector which, even when the control unit imposes reproduction restrictions on audio reproduction by the loudspeaker, allows the audio signal recovered by the processing unit to be externally output.

3. The information reproducing apparatus according to claim 1, wherein the control unit disables display of the video signal by the display unit when the restriction information extracted by the extraction unit prohibits video display and disables audio reproduction by the loudspeaker when the restriction information extracted by the extraction unit prohibits audio reproduction.

4. The information reproducing apparatus according to claim 1, wherein, when the restriction information extracted by the extraction unit prohibits video display and audio reproduction, the control unit causes the display unit to display a message that video display and audio reproduction are disabled by the restriction information.

5. The information reproducing apparatus according to claim 1, wherein, when the restriction information extracted by the extraction unit limits the volume of audio reproduction by the loudspeaker, the control unit keeps the volume to within a range of volume set in the restriction information.

6. The information reproducing apparatus according to claim 1, wherein the control unit displays on the display unit a message corresponding to the contents of the restriction information extracted by the extraction unit.

7. The information reproducing apparatus according to claim 1, wherein the control unit removes the reproduction restrictions when the receiving unit becomes disabled from receiving a signal transmitted from facilities.

8. The information reproducing apparatus according to claim 1, further comprising a determination unit which determines whether the information reproducing apparatus has been gone into or out of facilities which transmits the broadcast signal, and wherein the control unit starts reproduction restrictions when the determination unit determines that the information reproducing apparatus has been gone into the facilities and removes the reproduction restrictions when the determination unit determines that the information reproducing apparatus has been gone out of the facilities.

9. The information reproducing apparatus according to claim 1, wherein the control unit removes the reproduction restrictions upon the lapse of a previously set period of time after the start of reproduction restrictions.

10. A method of controlling an information reproducing apparatus equipped with a processing unit which recovers a video signal and an audio signal from input information, a display unit which displays the video signal recovered by the processing unit, and a loudspeaker which reproduces the audio signal recovered by the processing unit, the method comprising the steps of:
receiving a broadcast signal;
extracting restriction information from the received broadcast signal; and
when the extracted restriction information indicates restrictions on video display, imposing reproduction restrictions based on the restriction information on display of the video signal by the display unit, and when the extracted restriction information indicates restrictions on audio reproduction, imposing reproduction restrictions based on the restriction information on audio reproduction by the loudspeaker.

11. The control method according to claim 10, the information reproducing apparatus further comprises a determination unit which determines whether the information reproducing apparatus has been gone into or out of facilities which transmits the broadcast signal,
wherein the step of imposing reproduction restrictions includes substeps of:
starting reproduction restrictions when the information reproduction apparatus is determined to have been gone into the facilities by the determination unit; and
removing the reproduction restrictions when the information reproduction apparatus is determined to have been gone out of the facilities by the determination unit.

12. The control method according to claim 10, wherein the step of imposing reproduction restrictions includes a substep of:
removing the reproduction restrictions upon the lapse of a previously set period of time after start of the reproduction restrictions.
